(19) United States
(12) Patent Application Publication
(10) Pub. No.: US 2021/0012530 A1
(43) Pub. Date: Jan. 14, 2021

(54) IMAGE PROCESSING METHOD AND APPARATUS, ELECTRONIC DEVICE AND STORAGE MEDIUM

(71) Applicant: Beijing Sensetime Technology Development Co., Ltd., Beijing (CN)

(72) Inventor: Congyao ZHENG, Beijing (CN)

(21) Appl. No.: 17/038,273

(22) Filed: Sep. 30, 2020

Related U.S. Application Data
(63) Continuation of application No. PCT/CN2019/092866, filed on Jun. 25, 2019.

(30) Foreign Application Priority Data
Dec. 21, 2018 (CN) 201811572680.9

(51) Int. Cl. G06T 7/73; G06T 7/60; G06K 9/46

(52) U.S. Cl. CPC G06T 7/75; G06K 9/4671; G06T 7/60

(57) ABSTRACT

A 2D image comprising at least one target object is obtained. First 2D coordinate of a first key point and second 2D coordinate of a second key point are obtained from the 2D image. The first key point is an imaging point of a first part of the target object in the 2D image, and the second key point is an imaging point of a second part of the target object in the 2D image. Relative coordinate is determined based on the first 2D coordinate and the second 2D coordinate. The relative coordinate is used for characterizing a relative position between the first part and the second part. The relative coordinate is projected into a virtual three-dimensional space and 3D coordinate corresponding to the relative coordinate is obtained. The 3D coordinate is used for controlling coordinate conversion of the target object on a controlled device.

### CROSS REFERENCE TO RELATED APPLICATIONS

This application is a continuation of International application Serial No. PCT/CN2019/092866 filed Jun. 25, 2019, which claims priority to Chinese Patent Application No. 201811572680.9 filed on Dec. 21, 2018. The entire content of all of the above-referenced applications is incorporated herein by reference for all purposes.

### TECHNICAL FIELD

The present application relates to the field of information technology, and in particular, to an image processing method and apparatus, an electronic device and a storage medium.

### BACKGROUND

With the development of information technology, interactions based on 3D coordinates such as 3D videos and 3D motion sensing games have appeared. The 3D coordinates have coordinate values in one more direction than 2D coordinates. Thus, the 3D coordinates may have one more dimension of interaction than the 2D coordinates.

For example, user's movements in a 3D space are collected and converted into control over game characters in three mutually perpendicular directions such as longitudinal, lateral and vertical directions. If the control is implemented by utilizing the 2D coordinates, a user may need to input at least two operations, thereby simplifying user control and improving user experience.

Usually, such interactions based on the 3D coordinates require corresponding 3D device. For example, a user needs to wear a 3D motion sensing device (wearable device) to detect his/her movements in a three-dimensional space, or use a 3D camera to collect user's movements in a 3D space. Regardless of whether the user's movements in the 3D space are determined through the 3D motion sensing device or the 3D camera, hardware cost is relatively high.

### SUMMARY

In view of this, examples of the present application desire to provide an image processing method and apparatus, an electronic device and a storage medium.

Technical solutions in this application are implemented as follows:

An image processing method, comprising:

obtaining a 2D image comprising at least one target object;

obtaining first 2D coordinate of a first key point and second 2D coordinate of a second key point from the 2D image, wherein the first key point is an imaging point of a first part of the target object in the 2D image, and the second key point is an imaging point of a second part of the target object in the 2D image;

determining relative coordinate based on the first 2D coordinate and the second 2D coordinate, wherein the relative coordinate is used for characterizing a relative position between the first part and the second part;

projecting the relative coordinate into a virtual three-dimensional space and obtaining 3D coordinate corresponding to the relative coordinate, wherein the 3D coordinate is used for controlling coordinate conversion of the target object on a controlled device.

An image processing apparatus, comprising:

a first obtaining module configured to obtain a 2D image comprising at least one target object;

a second obtaining module configured to obtain first 2D coordinate of a first key point and second 2D coordinate of a second key point from the 2D image, wherein the first key point is an imaging point of a first part of the target object in the 2D image, and the second key point is an imaging point of a second part of the target object in the 2D image;

a first determining module configured to determine relative coordinate based on the first 2D coordinate and the second 2D coordinate, wherein the relative coordinate is used for characterizing a relative position between the first part and the second part;

a projecting module configured to project the relative coordinate into a virtual three-dimensional space and obtain 3D coordinate corresponding to the relative coordinate, wherein the 3D coordinate is used for controlling coordinate conversion of the target object on a controlled device.

An electronic device, comprising:

a memory; and

a processor connected to the memory and configured to implement an image processing method provided in any of the above-described technical solutions by executing computer executable instructions stored on the memory.

A computer storage medium having computer executable instructions stored thereon, wherein the computer executable instructions are executed by a processor to implement an image processing method provided in any of the above-described technical solutions.

A computer program, wherein the computer program is executed by a processor to implement an image processing method provided in any of the above-described technical solutions.

According to the technical solutions provided by the examples of the present application, the relative coordinate between the first key point of the first part and the second key point of the second part of the target object in the 2D image may be directly converted into the virtual three-dimensional space, thereby obtaining the 3D coordinate corresponding to the relative coordinate, and the 3D coordinate may be used for interactions with the controlled device, but it is needless to use the 3D motion sensing device to collect the 3D coordinate, thereby simplifying the hardware structure for performing the interactions based on the 3D coordinate and saving the hardware cost.

### BRIEF DESCRIPTION OF THE DRAWINGS

FIG. 1 is a schematic flowchart illustrating a first image processing method according to an example of the present application.

FIG. 2 is a schematic diagram illustrating a view frustum according to an example of the present application.

FIG. 3 is a schematic diagram illustrating a process of determining relative coordinates according to an example of the present application.

FIG. 4 is a schematic flowchart illustrating a second image processing method according to an example of the present application.

FIG. 5A is a schematic diagram illustrating a display effect according to an example of the present application.

FIG. 5B is a schematic diagram illustrating another display effect according to an example of the present application.

FIG. 6 is a schematic structural diagram illustrating an image processing apparatus according to an example of the present application.

FIG. 7 is a schematic structural diagram illustrating an electronic device according to an example of the present application.

### DETAILED DESCRIPTION OF THE EMBODIMENTS

The technical solutions in the present application will be further elaborated below with reference to the drawings and specific examples.

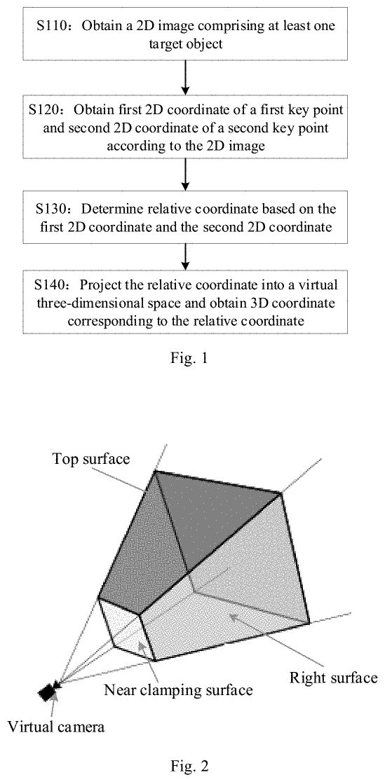

As shown in FIG. 1, in this example, an image processing method is provided, including the following steps.

At step S110, a 2D image comprising at least one target object is obtained.

At step S120, first 2D coordinate of a first key point and second 2D coordinate of a second key point are obtained from the 2D image, wherein the first key point is an imaging point of a first part of the target object in the 2D image, and the second key point is an imaging point of a second part of the target object in the 2D image.

At step S130, relative coordinate is determined based on the first 2D coordinate and the second 2D coordinate, wherein the relative coordinate is used to characterize a relative position between the first part and the second part.

At step S140, the relative coordinate is projected into a virtual three-dimensional space and 3D coordinate corresponding to the relative coordinate is obtained, wherein the 3D coordinate is used to control a controlled device to perform predetermined operations. Here, the predetermined operations include, but are not limited to, coordinate conversion of the target object on the controlled device.

In this example, the 2D (two-dimensional) image comprising at least one target object is obtained. Here, the 2D image may be an image collected by any 2D camera, for example, the 2D image is an RGB image collected by a common RGB camera, or a YUV image. For another example, the 2D image may be a 2D image in a format of BGRA. In this example, the acquiring of the 2D image may be implemented with a monocular camera located on the controlled device. Alternatively, the monocular camera may be a camera connected to the controlled device. A collecting region of the camera and a viewing region of the controlled device at least partially overlap each other. For example, the controlled device is a game device such as a smart TV. The game device includes a display screen. The viewing region represents a region where the display screen can be viewed. The collecting region represents a region where image data can be collected by the camera. In an example, the collecting region of the camera overlaps with the viewing region.

In this example, the step S110 of obtaining the 2D image may include: collecting the 2D image using a two-dimensional (2D) camera, or receiving the 2D image from a collecting device.

The target objects may include human hands and torso. The 2D image may be an image including the human hands and torso. For example, the first part is the human hands, and the second part is the torso. For another example, the first part may be eyeballs of eyes, and the second part may be entire eyes. Still for another example, the first part may be human feet, and the second part may be the human torso.

In some examples, an imaging area of the first part in the 2D image is smaller than an imaging area of the second part in the 2D image.

In this example, both the first 2D coordinate and the second 2D coordinate may be coordinate values in a first 2D coordinate system. For example, the first 2D coordinate system may be a 2D coordinate system formed in a plane where the 2D image is located.

At the step S130, the relative coordinate characterizing the relative position between the first key point and the second key point is determined with reference to the first 2D coordinate and the second 2D coordinate. Then the relative coordinate is projected into the virtual three-dimensional space to obtain a 3D coordinate of the relative coordinate in the virtual three-dimensional space, the virtual three-dimensional space being a preset three-dimensional space. The 3D coordinate may be used for interactions related to a display interface and based on the 3D coordinate.

The virtual three-dimensional space may be various types of virtual three-dimensional space, and coordinates of the virtual three-dimensional space may range from negative infinity to positive infinity. A virtual camera may be provided in the virtual three-dimensional space. FIG. 2 shows a view frustum corresponding to an angle of view of a virtual camera. In this example, the virtual camera may be a mapping of a physical camera of the 2D image in the virtual three-dimensional space. The view frustum may include a near clamping surface, a top surface, a right surface, a left surface (not marked in FIG. 2), and so on. In this example, a virtual viewpoint of the virtual three-dimensional space may be positioned on the near clamping surface. For example, the virtual viewpoint is determined as a center point of the near clamping surface. According to the view frustum shown in FIG. 2, relative coordinate (2D coordinate) of the first key point relative to the second key point may be converted into the virtual three-dimensional space to obtain 3D (three-dimensional) coordinate of the first key point relative to the second key point in a three-dimensional space.

The near clamping surface may also be called a front clipping plane, which is a plane close to the virtual viewpoint in the virtual three-dimensional space, and includes a starting plane of the virtual viewpoint. The virtual three-dimensional space gradually extends from the near clamping surface to a far end.

The interactions based on the 3D coordinate include performing operation control according to the coordinate conversion of the target object in the virtual three-dimensional space between two time points. For example, taking the control over a game character as an example, the interactions based on the 3D coordinate include:

controlling parameters of the game character on three coordinate axes in the virtual three-dimensional space based on amount of change or a change rate of the relative coordinate between two time points on the corresponding three coordinate axes. For example, taking the control over movements of the game character as an example, the movements of the game character in the three-dimensional space may include back and forth movements, left and right movements, and up and down jumping. After the relative coordinate of a user hand relative to a torso is converted into the three-dimensional space, the game character is controlled to move back and forth, left and right, and up and down respectively according to a coordinate conversion amount or change rate of the relative coordinate converted into a virtual three-dimensional space between two time points. Specifically, for example, a coordinate obtained by projecting a relative coordinate on an x axis in the virtual three-dimensional space is used to control the game character to move forward and backward, a coordinate obtained by projecting a relative coordinate on a y axis in the virtual three-dimensional space is used to control the game character to move left and right, a coordinate obtained by projecting a relative coordinate on a z axis in the virtual three-dimensional space is used to control the game character to jump up and down.

In some examples, a display image in a display interface may be divided into at least a background layer and a foreground layer. It may be determined, according to the position of a current 3D coordinate on the z axis in the virtual three-dimensional space, whether the 3D coordinate controls the conversion of graphic elements on the background layer or corresponding response operation, or controls the conversion of graphic elements on the foreground layer or corresponding response operation.

In some other examples, a display image in a display interface may be further divided into: a background layer, a foreground layer, and one or more intermediate layers between the background layer and the foreground layer. Similarly, a layer on which the 3D coordinate acts may be determined according to a currently obtained coordinate value of the 3D coordinate on the z axis. Then, a graphic element on the layer on which the 3D coordinate acts may be determined with reference to the coordinate values of the 3D coordinate on the x axis and the y axis. Further, the conversion for the graphic element on which the 3D coordinate acts or its corresponding response operation is controlled.

Of course, the above are only examples of performing the interactions based on the 3D coordinate. There are many specific implementation manners, which are not limited to any of the above.

The virtual three-dimensional space may be a predefined three-dimensional space. Specifically, for example, the virtual three-dimensional space is predefined according to parameters for collecting the 2D image. The virtual three-dimensional space may include: a virtual imaging plane and a virtual viewpoint. A vertical distance between the virtual viewpoint and the virtual imaging plane may be determined according to a focal distance in the collecting parameters. In some examples, a size of the virtual imaging plane may be determined according to a size of a controlled plane of a controlled device. For example, the size of the virtual imaging plane is positively correlated with the size of the controlled plane of the controlled device. The size of the controlled plane may be equal to a size of a display interface for receiving the interactions based on the 3D coordinate.

Thus, in this example, by projecting the relative coordinate into the virtual three-dimensional space, a 2D camera can be used to achieve a control effect of performing interactions based on a 3D coordinate obtained through a depth camera or a 3D motion sensing device. Since the hardware cost of the 2D camera is generally lower than that of the 3D motion sensing device or a 3D camera, the use of the 2D camera realizes the interactions based on the 3D coordinate while reducing the cost of the interactions significantly. Therefore, in some examples, the method further includes interacting with a controlled device based on the 3D coordinate. The interaction may include an interaction between a user and the controlled device. The 3D coordinate may be regarded as a user input for controlling the controlled device to perform specific operation, to realize the interaction between the user and the controlled device.

Therefore, in some examples, the method further includes: controlling the coordinate conversion of the target object on the controlled device based on amount of change or a change rate of the relative coordinate on three coordinate axes in the virtual three-dimensional space between two time points.

In some examples, the step S120 may include: obtaining the first 2D coordinate of the first key point in a first 2D coordinate system corresponding to the 2D image, and obtaining the second 2D coordinate of the second key point in the first 2D coordinate system. That is, both of the first 2D coordinate and the second 2D coordinate are determined based on the first 2D coordinate system.

In some examples, the step S130 may include: constructing a second 2D coordinate system according to the second 2D coordinate, and mapping the first 2D coordinate to the second 2D coordinate system to obtain third 2D coordinate.

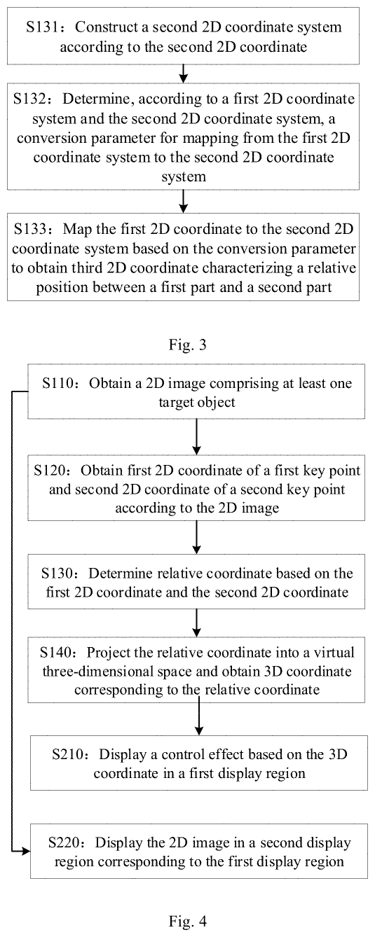

Specifically, as shown in FIG. 3, the step S130 may include the following steps.

At step S131, a second 2D coordinate system is constructed according to the second 2D coordinate.

At step S132, a conversion parameter of mapping from the first 2D coordinate system to the second 2D coordinate system is determined according to the first 2D coordinate system and the second 2D coordinate system, wherein the conversion parameter is used to determine the relative coordinate.

In some examples, the step S130 may further include the following steps.

At step S133, the first 2D coordinate is mapped to the second 2D coordinate system based on the conversion parameter to obtain the third 2D coordinate.

In this example, there are at least two second key points of the second part. For example, the second key points may include outer contour imaging points of the second part. A second 2D coordinate system may be constructed according to coordinates of the second key points. An origin of the second 2D coordinate system may be a center point of an outer contour formed by connecting a plurality of the second key points.

In the examples of the present application, both of the first 2D coordinate system and the second 2D coordinate system are bordered coordinate systems.

After the first 2D coordinate system and the second 2D coordinate system are determined, a conversion parameter for mapping coordinates in the first 2D coordinate system into the second 2D coordinate system may be obtained according to sizes and/or center coordinates of the two 2D coordinate systems.

Based on the conversion parameter, the first 2D coordinate may be directly mapped to the second 2D coordinate system to obtain the third 2D coordinate. For example, the third 2D coordinate is a coordinate obtained after mapping the first 2D coordinate to the second 2D coordinate system.

In some examples, the step S132 may include:

determining a first size of the 2D image in a first direction, and determining a second size of the second part in the first direction;

determining a first ratio between the first size and the second size; and determining the conversion parameter based on the first ratio.

In some other examples, the step S132 may further include:

determining a third size of the 2D image in a second direction, and determining a fourth size of the second part in the second direction, wherein the second direction is perpendicular to the first direction;

determining a second ratio between the third size and the fourth size; and

determining the conversion parameter between the first 2D coordinate system and the second 2D coordinate system with reference to the first ratio and the second ratio.

For example, the first ratio may be a conversion ratio of the first 2D coordinate system and the second 2D coordinate system in the first direction, and the second ratio may be a conversion ratio of the first 2D coordinate system and the second 2D coordinate system in the second direction.

In this example, if the first direction is a direction corresponding to an x axis, the second direction is a direction corresponding to a y axis, and if the first direction is a direction corresponding to a y axis, the second direction is a direction corresponding to an x axis.

In this example, the conversion parameter includes two conversion ratios, which are the first ratio between the first size and the second size in the first direction, and the second ratio between the third size and the fourth size in the second direction.

In some examples, the step S132 may include:

determining the conversion parameter using the following functional relationship:

$$[ K = \frac{{cam}_{w}}{{torso}_{w}} , S = \frac{{cam}_{h}}{{torso}_{h}} ] . \qquad Formula ( 1 )$$

Wherein cam_{w} indicates the first size; torso_{w} indicates the second size; camₕ indicates the third size; torsoₕ indicates the fourth size; K indicates the conversion parameter for mapping the first 2D coordinate to the second 2D coordinate system in the first direction; S indicates the conversion parameter for mapping the first 2D coordinate to the second 2D coordinate system in the second direction.

The cam_{w} may be a distance between two edges of the 2D image in the first direction. The camₕ may be a distance between the two edges of the 2D image in the second direction. The first direction and the second direction are perpendicular to each other.

The K is the first ratio, and the S is the second ratio. In some examples, in addition to the first ratio and the second ratio, the conversion parameter may also involve an adjusting factor. For example, the adjusting factor includes: a first adjusting factor and/or a second adjusting factor. The adjusting factor may include a weighting factor and/or a scaling factor. If the adjusting factor is a scaling factor, the conversion parameter may be a product of the first ratio and/or the second ratio and the scaling factor. If the adjusting factor is a weighting factor, the conversion parameter may be a weighted sum of the first ratio and/or the second ratio and the weighting factor.

In some examples, the step S133 may include: mapping the first 2D coordinate to the second 2D coordinate system based on the conversion parameter and a center coordinate of the first 2D coordinate system to obtain the third 2D coordinate. To a certain extent, the third 2D coordinate may represent a position of the first part relative to the second part.

Specifically, for example, the step S133 may include: determining the third 2D coordinate using the following functional relationship:

(x₃,y₃)=((x₁−xₜ)*K+xᵢ,(y₁−yₜ)*S+yᵢ) Formula (2)

(x₃, y₃) indicates the third 2D coordinate; (x₁, y₁) indicates the first 2D coordinate; (xₜ, yₜ) indicates the coordinate of a center point of the second part in the first 2D coordinate system; (xᵢ, yᵢ) indicates the coordinate of a center point of the 2D image in the first 2D coordinate system.

In this example, x represents a coordinate value in the first direction, andy represents a coordinate value in the second direction.

In some examples, the step S140 may include:

normalizing the third 2D coordinate to obtain fourth 2D coordinate; and

determining, with reference to the fourth 2D coordinate and a distance from a virtual viewpoint to a virtual imaging plane in the virtual three-dimensional space, 3D coordinate of the first key point projected into the virtual three-dimensional space.

In some examples, the third 2D coordinate may be directly projected so that the third 2D coordinate is projected into the virtual imaging plane. In this example, in order to facilitate calculation, the third 2D coordinate is normalized, and thereafter projected into the virtual imaging plane.

In this example, the distance between the virtual viewpoint and the virtual imaging plane may be a known distance.

The normalization may be performed based on the size of the 2D image or based on a predefined size. The normalization has many ways. The normalization reduces inconvenience of data processing caused by a great change in the third 2D coordinates of the 2D image collected at different time points, and simplifies subsequent data processing.

In some examples, normalizing the third 2D coordinate to obtain the fourth 2D coordinate comprises: normalizing the third 2D coordinate with reference to a size of the second part and a center coordinate of the second 2D coordinate system to obtain the fourth 2D coordinate.

For example, normalizing the third 2D coordinate with reference to the size of the second part and the center coordinate of the second 2D coordinate system to obtain the fourth 2D coordinate includes:

(x₄,y₄)=[((x₁−xₜ)*K+xᵢ))torso_{w},(1−((y₁−yₜ)*S+yᵢ))/torsoₕ] Formula (3)

Wherein (x₄, y₄) indicates the fourth 2D coordinate; (x₁, y₁) indicates the first 2D coordinate; (xₜ, yₜ) indicates the coordinate of the center point of the second part in the first 2D coordinate system; (xᵢ, yᵢ) indicates the coordinate of a center point of the 2D image in the first 2D coordinate system. The 2D image is generally a rectangle. Here, the center point of the 2D image is a center point of the rectangle. torso_{w} indicates the size of the 2D image in the first direction; torsoₕ indicates the size of the 2D image in the second direction; K indicates the conversion parameter for mapping the first 2D coordinate to the second 2D coordinate system in the first direction; S indicates the conversion parameter for mapping the first 2D coordinate to the second 2D coordinate system in the second direction; the first direction is perpendicular to the second direction.

Since the center coordinate value of the second 2D coordinate system is: (0.5*torso_{w}, 0.5*torsoₕ), a solving function of the fourth 2D coordinate may be as shown below:

$$\begin{matrix}( {x}_{4} , {y}_{4} ) = [ ( ( {x}_{1} - {x}_{t} ) * K + {x}_{i} ) / {torso}_{w} , \\ ( 1 - ( ( {y}_{1} - {y}_{t} ) * S + {y}_{i} ) ) / {torso}_{h} ] \\ = [ ( ( {x}_{1} - {x}_{t} ) * \frac{{cam}_{w}}{t o r s {o}_{w}} + 0.5 * {cam}_{w} / {torso}_{w} , \\ ( 1 - ( ( {y}_{1} - {y}_{t} ) * \frac{{cam}_{h}}{t o r s {o}_{h}} + 0.5 * {cam}_{h} ) ) / \\ {torso}_{h} ] \\ = [ ( {x}_{1} - {x}_{t} ) * {cam}_{w} + 0.5 , 0.5 - \\ ( {y}_{1} - {y}_{t} ) * {cam}_{h} ]\end{matrix} \qquad Formula ( 4 )$$

In some examples, determining, with reference to the fourth 2D coordinate and the distance from the virtual viewpoint to the virtual imaging plane in the virtual three-dimensional space, the 3D coordinate of the first key point projected into the virtual three-dimensional space comprises: determining the 3D coordinate of the first key point projected into the virtual three-dimensional space with reference to the fourth 2D coordinate, the distance from the virtual viewpoint to the virtual imaging plane in the virtual three-dimensional space, and a scaling ratio. Specifically, for example, the 3D coordinate may be determined using the following functional relationship:

(x₄*dds,y₄*dds,d) Formula (5)

Wherein x4 indicates the coordinate value of the fourth 2D coordinate in the first direction; y4 indicates the coordinate value of the fourth 2D coordinate in the second direction; dds indicates the scaling ratio; d indicates the distance from the virtual viewpoint to the virtual imaging plane in the virtual three-dimensional space.

In this example, the scaling ratio may be a predetermined static value, or be determined dynamically according to a distance of an object to be captured (e.g. a user) from a camera.

In some examples, the method further includes:

determining a number M of the target objects and a 2D imaging region of each target object in the 2D image.

The step S120 may include:

obtaining first 2D coordinate of a first key point and second 2D coordinate of a second key point of each target object according to the 2D imaging region to obtain M sets of 3D coordinates.

For example, how many controlled users there are in one 2D image may be detected by contour detection such as face detection or other processing, and then corresponding 3D coordinates are obtained based on each controlled user.

For example, if images of 3 users are detected in one 2D image, imaging regions of the 3 users in the 2D image need to be obtained respectively, and then 3D coordinates respectively corresponding to the 3 users in the virtual three-dimensional space may be obtained by performing the steps S130 to S150 based on 2D coordinates of key points of hands and torsos of the 3 users.

In some examples, as shown in FIG. 4, the method includes:

step S210: displaying a control effect based on the 3D coordinate in a first display region;

step S220: displaying the 2D image in a second display region corresponding to the first display region.

In order to improve user experience and facilitate users to modify their actions according to contents in the first display region and the second display region, the control effect will be displayed in the first display region, and the 2D image is displayed in the second region.

In some examples, the first display region and the second display region may correspond to different display screens. For example, the first display region may correspond to a first display screen, and the second display region may correspond to a second display screen. The first display screen and the second display screen are arranged in parallel.

In some other examples, the first display region and the second display region may be different display regions of the same display screen. The first display region and the second display region may be two display regions arranged in parallel.

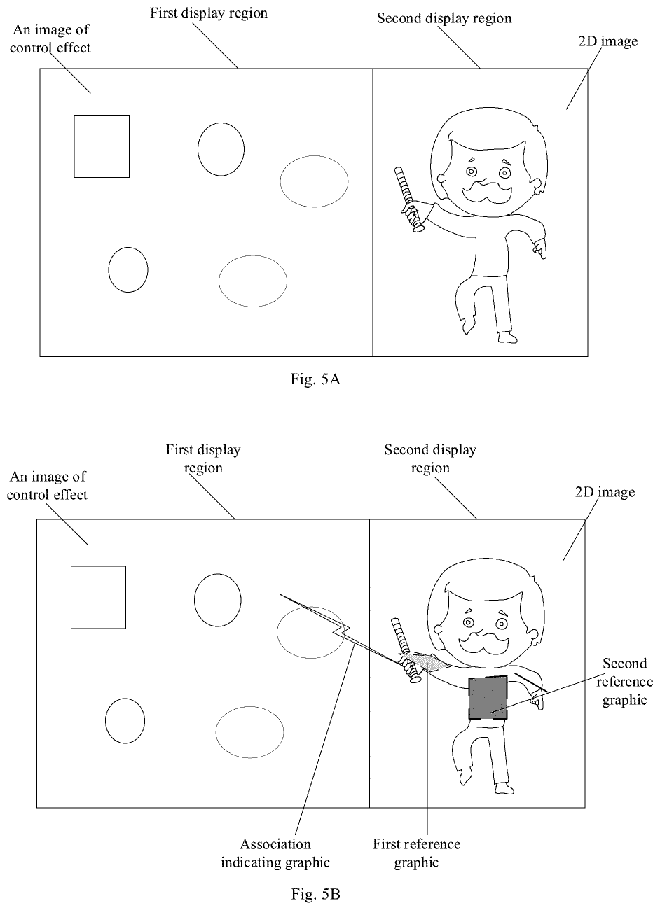

As shown in FIG. 5A, an image with a control effect is displayed in the first display region, and a 2D image is displayed in the second display region arranged in parallel to the first display region. In some examples, the 2D image displayed in the second display region is a 2D image currently collected in real time or a video frame currently collected in real time from a 2D video.

In some examples, displaying the 2D image in the second display region corresponding to the first display region comprises:

displaying, according to the first 2D coordinate, a first reference graphic of the first key point on the 2D image displayed in the second display region; and/or,

displaying, according to the second 2D coordinate, a second reference graphic of the second key point on the 2D image displayed in the second display region.

In some examples, the first reference graphic is superimposing displayed on the first key point. By displaying the first reference graphic, the position of the first key point may be highlighted. For example, display parameters such as colors and/or brightness used for the first reference graphic are distinguished from that for imaging other parts of a target object.

In some other examples, the second reference graphic is also superimposing displayed on the second key point, so that it is convenient for a user to visually determine a relative positional relationship between his/her first part and second part according to the first reference graphic and the second reference graphic, and subsequently perform a targeted adjustment.

For example, display parameters such as colors and/or brightness used for the second reference graphic are distinguished from that for imaging other parts of a target object.

In some examples, in order to distinguish the first reference graphic from the second reference graphic, the display parameters of the first reference graphic and the second reference graphic are different, facilitating a user to distinguish easily through a visual effect and improving user experience.

In yet other examples, the method further includes:

generating an association indicating graphic, wherein one end of the association indicating graphic points to the first reference graphic, and the other end of the association indicating graphic points to a controlled element on a controlled device.

The controlled element may include controlled objects such as a game object or a cursor displayed on the controlled device.

As shown in FIG. 5B, the first reference graphic and/or the second reference graphic are also displayed on the 2D image displayed in the second display region. Moreover, the association indicating graphic is displayed on both of the first display region and the second display region.

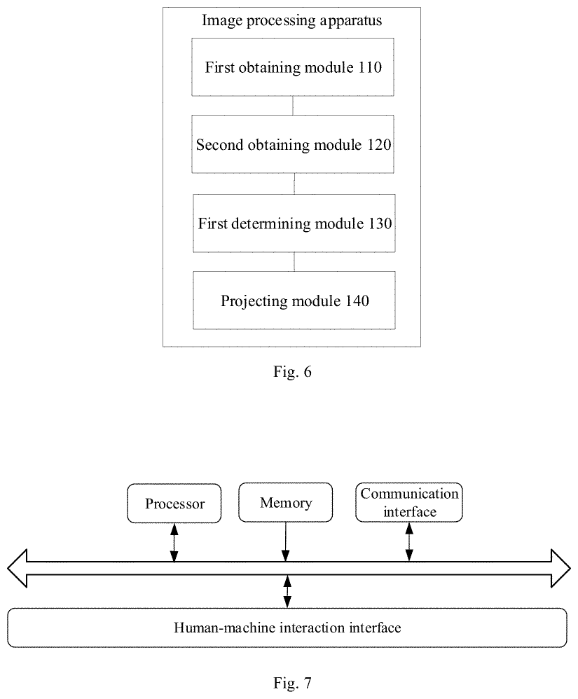

As shown in FIG. 6, the example provides an image processing apparatus, including:

a first obtaining module 110 configured to obtain a 2D image comprising at least one target object;

a second obtaining module 120 configured to obtain first 2D coordinate of a first key point and second 2D coordinate of a second key point from the 2D image, wherein the first key point is an imaging point of a first part of the target object in the 2D image, and the second key point is an imaging point of a second part of the target object in the 2D image;

a first determining module 130 configured to determine relative coordinate based on the first 2D coordinate and the second 2D coordinate, wherein the relative coordinate is used for characterizing a relative position between the first part and the second part;

a projecting module 140 configured to project the relative coordinate into a virtual three-dimensional space and obtain 3D coordinate corresponding to the relative coordinate, wherein the 3D coordinate is used for characterizing control a controlled device to perform predetermined operations. Here, the predetermined operations include, but are not limited to, coordinate conversion of the target object on the controlled device.

In some examples, the first obtaining module 110, the second obtaining module 120, the first determining module 130 and the projecting module 140 may be program modules. The program modules are executed by a processor to realize functions of the above modules.

In some other examples, the first obtaining module 110, the second obtaining module 120, the first determining module 130 and the projecting module 140 may be modules involving software and hardware. The modules involving software and hardware may include various programmable arrays such as complex programmable arrays or field programmable arrays.

In yet other examples, the first obtaining module 110, the second obtaining module 120, the first determining module 130 and the projecting module 140 may be pure hardware modules. Such hardware modules may be application-specific integrated circuits.

In some examples, the first 2D coordinates and the second 2D coordinates are 2D coordinates located in a first 2D coordinate system.

In some examples, the second obtaining module 120 is configured to obtain the first 2D coordinate of the first key point in a first 2D coordinate system corresponding to the 2D image, and obtain the second 2D coordinate of the second key point in the first 2D coordinate system;

the first determining module 130 is configured to construct a second 2D coordinate system according to the second 2D coordinate, and map the first 2D coordinate into the second 2D coordinate system to obtain third 2D coordinate.

In some other examples, the first determining module 130 is further configured to determine, according to the first 2D coordinate system and the second 2D coordinate system, a conversion parameter used for mapping from the first 2D coordinate system to the second 2D coordinate system, and map the first 2D coordinate into the second 2D coordinate system based on the conversion parameter to obtain the third 2D coordinate.

In some examples, the first determining module 130 is configured to determine a first size of the 2D image in a first direction, and determine a second size of the second part in the first direction; determine a first ratio between the first size and the second size; and determine the conversion parameter according to the first ratio.

In some other examples, the first determining module 130 is further configured to determine a third size of the 2D image in a second direction, and determine a fourth size of the second part in the second direction, wherein the second direction is perpendicular to the first direction; determine a second ratio between the third size and the fourth size; and determine the conversion parameter between the first 2D coordinate system and the second 2D coordinate system with reference to the first ratio and the second ratio.

In some examples, the first determining module 130 is specifically configured to determine the conversion parameter using the following functional relationship:

$$[ K = \frac{c a {m}_{w}}{t o r s {o}_{w}} , S = \frac{c a {m}_{h}}{t o r s {o}_{h}} ] \qquad Formula ( 1 )$$

Wherein cam_{w} indicates the first size; torso_{w} indicates the second size; camₕ indicates the third size; torsoₕ indicates the fourth size; K indicates the conversion parameter used for mapping the first 2D coordinate into the second 2D coordinate system in the first direction; S indicates the conversion parameter used for mapping the first 2D coordinate into the second 2D coordinate system in the second direction.

In some examples, the first determining module 130 is configured to determine the third 2D coordinate using the following functional relationship:

(x₃,y₃)=((x₁−xₜ)*K+xᵢ,(y₁−yₜ)*S+yᵢ) Formula (2)

(x₃, y₃) indicates the third 2D coordinate; (x₁, y₁) indicates the first 2D coordinate; (xₜ, yₜ) indicates the coordinate of a center point of the second part in the first 2D coordinate system; (xᵢ, yᵢ) indicates the coordinate of a center point of the 2D image in the first 2D coordinate system.

In some examples, the projecting module 140 is configured to normalize the third 2D coordinate to obtain fourth 2D coordinate, and determine, with reference to the fourth 2D coordinate and a distance from a virtual viewpoint to a virtual imaging plane in the virtual three-dimensional space, 3D coordinate of the first key point projected into the virtual three-dimensional space.

In some examples, the projecting module 140 is configured to normalize the third 2D coordinate with reference to a size of the second part and a center coordinate of the second 2D coordinate system to obtain the fourth 2D coordinate.

In some examples, the projecting module 140 is configured to determine the 3D coordinate of the first key point projected into the virtual three-dimensional space with reference to the fourth 2D coordinate, the distance from the virtual viewpoint to the virtual imaging plane in the virtual three-dimensional space, and a scaling ratio.

In some examples, the projecting module 140 may be configured to determine the 3D coordinate based on the following functional relationship:

(x₄,y₄)=[((x₁−xₜ)*K+xᵢ)/torso_{w},(1−((y₁−yₜ)*S+yᵢ))/torsoₕ] Formula (3)

Wherein (x₄, y₄) indicates the fourth 2D coordinate; (x₁, y₁) indicates the first 2D coordinate; (xₜ, yₜ) indicates the coordinate of the center point of the second part in the first 2D coordinate system; (xᵢ, yᵢ) indicates the coordinate of a center point of the 2D image in the first 2D coordinate system; torso_{w} indicates the size of the 2D image in the first direction; torsoₕ indicates the size of the 2D image in the second direction; K indicates the conversion parameter used for mapping the first 2D coordinate into the second 2D coordinate system in the first direction; S indicates the conversion parameter used for mapping the first 2D coordinate into the second 2D coordinate system in the second direction; the first direction is perpendicular to the second direction.

In some examples, the projecting module 140 is configured to determine the 3D coordinate of the first key point projected into the virtual three-dimensional space, with reference to the fourth 2D coordinate, the distance from the virtual viewpoint to the virtual imaging plane in the virtual three-dimensional space, and a scaling ratio.

Further, the projecting module 140 may be configured to determine the 3D coordinate using the following functional relationship:

(x₄*dds,y₄*dds,d) Formula (5)

Wherein x4 indicates the coordinate value of the fourth 2D coordinate in the first direction; y4 indicates the coordinate value of the fourth 2D coordinate in the second direction; dds indicates the scaling ratio; d indicates the distance from the virtual viewpoint to the virtual imaging plane in the virtual three-dimensional space.

In some examples, the apparatus further includes:

a second determining module configured to determine a number M of the target objects and a 2D imaging region of each target object in the 2D image.

The second obtaining module 120 is configured to obtain first 2D coordinate of the first key point and second 2D coordinate of the second key point of each target object according to the 2D imaging region to obtain M sets of 3D coordinates.

In some examples, the apparatus includes:

a first displaying module configured to display a control effect based on the 3D coordinate in a first display region; and

a second displaying module configured to display the 2D image in a second display region corresponding to the first display region.

In some examples, the second displaying module is further configured to display, according to the first 2D coordinate, a first reference graphic of the first key point on the 2D image displayed in the second display region; and/or, display, according to the second 2D coordinate, a second reference graphic of the second key point on the 2D image displayed in the second display region.

In some examples, the apparatus further includes:

a controlling module configured to control the coordinate conversion of the target object on the controlled device based on amount of change or a change rate of the relative coordinate on three coordinate axes in the virtual three-dimensional space between two time points.

A specific example is provided below in conjunction with any of the above embodiments.

### Example 1

This example provides an image processing method, including the following steps.

A human posture key point is identified in real time, and it can be achieved to perform high-precision operations in a virtual environment by using formulas and algorithms and without holding or wearing a device.

A face recognition model and a human posture key point recognition model are read and handles corresponding thereto are established while trace parameters are configured.

Video streams are started. For each frame, the frame is converted to a BGRA format, and is subjected to a reverse operation as needed. The obtained data streams are stored as objects with time stamps.

The current frame is detected by a face handle to obtain a face recognition result and a number of faces. This result assists in tracking the human posture key point.

A human posture is detected for the current frame, and the human posture key point is tracked in real time by tracking handles.

The human posture key point is located in a hand key point after obtained, so that pixel points of a hand in a camera recognition image are obtained. The hand key point is the first key point as described above. For example, the hand key point may be specifically a wrist key point.

Here, it is assumed that the hand will become an operation cursor later.

A human shoulder key point and a human waist key point are located in the same way, and pixel coordinates of a center position of a human body are calculated. The human shoulder key point and the human waist key point may be torso key points, which are the second key points as mentioned in the above embodiments.

A very center of an image is used as an origin to re-mark the above coordinates for later three dimensional conversion.

An upper part of the human body is set as a reference to find a relative coefficient between a scene and the human body.

In order to enable a posture control system to maintain stable performance in different scenes, that is, in order to achieve the same control effect regardless of where a user is located under a camera or how far the user is away from the camera, a relative position of the operation cursor and a center of the human body is used.

New coordinates of the hand relative to the human body are calculated through the relative coefficient, re-marked hand coordinates and human body center position coordinates.

The new coordinates and a recognition space, that is, a ratio of X to Y in a camera image size, are retained.

An operation space to be projected is generated in a virtual three-dimensional space. A distance D between a viewpoint and an object receiving operations is calculated. Coordinates of the viewpoint are converted into coordinates of the operation cursor in the three-dimensional space through the X, Y and D.

If there is a virtual operation plane, x and y values of the coordinates of the operation cursor are taken and put into a perspective projection and screen mapping formula to obtain pixel points in an operation screen space.

It may be applicable to cases when multiple users or multiple cursors perform operations simultaneously.

It is assumed that coordinate of a lower left corner in a first 2D coordinate system corresponding to a 2D image collected by a camera is (0, 0), and coordinate of an upper right corner therein is (cam_{w}, camₕ).

It is assumed that coordinate of the hand key point in the first 2D coordinate system corresponding to the 2D image is (x₁, y₁).

It is assumed that coordinate of a torso center point in the first 2D coordinate system is (xₜ,yₜ).

It is assumed that coordinate of a center point of the 2D image in the first 2D coordinate system is (xᵢ, yᵢ).

Then there exists a conversion parameter as follows.

The conversion parameter is:

$$[ K = \frac{c a {m}_{w}}{t o r s {o}_{w}} , S = \frac{c a {m}_{h}}{t o r s {o}_{h}} ] . \qquad Formula ( 1 )$$

A function of converting the hand key point into a second 2D coordinate system corresponding to the torso may be as follows:

(x₃,y₃)=((x₁−xₜ)*K+xᵢ,(y₁−yₜ)*S+yᵢ) Formula (6).

If the coordinate of the lower left corner in the first 2D coordinate system corresponding to the 2D image collected by the camera is (0, 0), and the coordinate of the lower right corner therein is (cam_{w}, camₕ),

the function of converting the hand key point into the second 2D coordinate system corresponding to the torso may be as follows:

(x₃,y₃)=((x₁−xₜ)*K+xᵢ,(yₜ−y₁)*S+yᵢ) Formula (6)

After combination, the function of converting the hand key point into the second 2D coordinate system corresponding to the torso may be:

(Hand-torso)*(cam/torso)+cam-center,

wherein hand represents the coordinate of the hand key point in the first 2D coordinate system; torso represents the coordinate of the torso key point in the first 2D coordinate system; cam-center represents the coordinate of a center in the first 2D coordinate system corresponding to the 2D image.

During the normalization, a scaling ratio may be introduced. The value range of the scaling ratio may be between 1 and 3, or between 1.5 and 2.

In the virtual three-dimensional space, the following coordinates may be obtained according to the constructed virtual three-dimensional space:

coordinate of a virtual viewpoint: (x_{c}, y_{c}, z_{c}), and

coordinate of a virtual controlled plane: (xⱼ, yⱼ, zⱼ).

d may be a distance between (x_{c}, y_{c}, z_{c}) and (xⱼ, yⱼ, zⱼ).

After the normalization, normalized fourth 2D coordinate will be:

(x₄,y₄)=[(x₁−xₜ)*cam_{w}+0.5,0.5−(y₁−yₜ)*camₕ] Formula (7).

3D coordinate converted into the virtual three-dimensional space may be:

$$( {x}_{4} , {y}_{4} ) = [ ( \frac{{x}_{1} - {x}_{t}}{t o r s {o}_{w}} + 0.5 ) * dds , ( 0.5 - \frac{{y}_{1} - {y}_{t}}{t o r s {o}_{h}} ) * dds , d ] . \qquad Formula ( 8 )$$

As shown in FIG. 7, an example of the present application provides an image processing apparatus, including:

a memory for storing information; and

a processor connected to the memory and configured to implement an image processing method provided in one or more of the above-described technical solutions, for example, one or more of the methods shown in FIG. 1, FIG. 3 and FIG. 4, by executing computer executable instructions stored on the memory.

The memory may include various types of memories such as a Random Access Memory, a Read-Only Memory and a flash memory. The memory may be used for storing information, for example, computer executable instructions. The computer executable instructions may include various program instructions, for example, target program instructions and/or source program instructions.

The processor may include various types of processors such as a central processing unit, a microprocessor, a digital signal processor, a programmable array, a digital signal processor, an application specific integrated circuit or an image processor.

The processor may be connected to the memory through a bus. The bus may be an integrated circuit bus or the like.

In some examples, the terminal device may include a communication interface. The communication interface may include a network interface such as a local area network interface, a transceiver antenna, and the like. The communication interface is also connected to the processor and can be used for information transmission and reception.

In some examples, the image processing apparatus further includes a camera. The camera may be a 2D camera, and can collect 2D images.

In some examples, the terminal device further includes a human-machine interaction interface. For example, the human-machine interaction interface may include various input and output devices such as a keyboard and a touch screen.

An example of the present application provides a computer storage medium having computer executable codes stored thereon. The computer executable codes are executed to implement an image processing method provided in one or more of the above-described technical solutions, for example, one or more of the methods shown in FIG. 1, FIG. 3 and FIG. 4.

The storage medium includes a mobile storage device, a Read-Only Memory (ROM), a Random Access Memory (RAM), a magnetic disk or an optical disc, and other media that can store program codes. The storage medium may be a non-transitory storage medium.

An example of the present application provides a computer program product. The program product includes computer executable instructions. The computer executable instructions are executed to implement an image processing method provided in any of the above-described examples, for example, one or more of the methods shown in FIG. 1, FIG. 3 and FIG. 4.

In several examples provided in this application, it should be understood that the disclosed device and method may be implemented in other ways. The device examples described above are only schematic. For example, the division of units is only the division of logical functions, and in actual implementation, there may be other division manners, for example, multiple units or components may be combined, or integrated into another system, or some features may be ignored, or not be implemented. In addition, the coupling or direct coupling or communication connection between displayed or discussed components may be through some interfaces, and the indirect coupling or communication connection between devices or units may be electrical, mechanical or in other forms.

The units described as separate components may or may not be physically separated, and the components displayed as units may or may not be physical units, i.e., may be located in one place or may be distributed to multiple network units. Some or all of the units may be selected according to actual needs to achieve the objectives of the present application.

In addition, all functional units in the examples of the present application may be integrated into one processing module, or each unit may be used separately as one unit, or two or more units may be integrated into one unit. The integrated units may be implemented in the form of hardware, or in the form of hardware and software functional units.

Those of ordinary skill in the art may understand that all or part of steps to implement the method examples may be completed by program instructions related hardware. The program may be stored in a computer readable storage medium, and the program is executed to perform steps including the steps in the method examples. The storage medium includes a mobile storage device, a Read-Only Memory (ROM), a Random Access Memory (RAM), a magnetic disk or an optical disc, and other media that can store program codes.

The above are only the specific embodiments of the present application, but the protection scope of this application is not limited thereto. All changes or replacements that any person skilled in the art can readily envisage within the technical scope disclosed in this application shall be contained in the protection scope of the application. Therefore, the protection scope of the present application shall be based on the protection scope of the claims.

1. An image processing method, comprising:
obtaining a two-dimensional (2D) image comprising at least one target object;
obtaining first 2D coordinate of a first key point and second 2D coordinate of a second key point from the 2D image, wherein the first key point is an imaging point of a first part of the target object in the 2D image, and the second key point is an imaging point of a second part of the target object in the 2D image;
determining relative coordinate based on the first 2D coordinate and the second 2D coordinate, wherein the relative coordinate is used for characterizing a relative position between the first part and the second part;
projecting the relative coordinate into a virtual three-dimensional (3D) space and obtaining 3D coordinate corresponding to the relative coordinate, wherein the 3D coordinate is used for controlling coordinate conversion of the target object on a controlled device.

2. The method according to claim 1, wherein the first 2D coordinate and the second 2D coordinate are 2D coordinates located in a first 2D coordinate system;
wherein determining the relative coordinate based on the first 2D coordinate and the second 2D coordinate comprises:
constructing a second 2D coordinate system according to the second 2D coordinate;
mapping the first 2D coordinate into the second 2D coordinate system to obtain third 2D coordinate;
determining the relative coordinate based on the third 2D coordinate.

3. The method according to claim 2, wherein mapping the first 2D coordinate into the second 2D coordinate system to obtain the third 2D coordinate comprises:
determining, according to the first 2D coordinate system and the second 2D coordinate system, a conversion parameter for mapping from the first 2D coordinate system to the second 2D coordinate system;
mapping the first 2D coordinate into the second 2D coordinate system based on the conversion parameter to obtain the third 2D coordinate.

4. The method according to claim 3, wherein determining, according to the first 2D coordinate system and the second 2D coordinate system, the conversion parameter for mapping from the first 2D coordinate system to the second 2D coordinate system comprises:
determining a first size of the 2D image in a first direction, and determining a second size of the second part in the first direction;
determining a first ratio between the first size and the second size;
determining the conversion parameter according to the first ratio.

5. The method according to claim 4, wherein determining the conversion parameter according to the first ratio comprises:
determining a third size of the 2D image in a second direction, and determining a fourth size of the second part in the second direction, wherein the second direction is perpendicular to the first direction;
determining a second ratio between the third size and the fourth size;
determining the conversion parameter with reference to the first ratio and the second ratio.

6. The method according to claim 3, wherein mapping the first 2D coordinate into the second 2D coordinate system based on the conversion parameter to obtain the third 2D coordinate comprises:
mapping, based on the conversion parameter and a center coordinate of the first 2D coordinate system, the first 2D coordinate into the second 2D coordinate system to obtain the third 2D coordinate.

7. The method according to claim 2, wherein projecting the relative coordinate into the virtual three-dimensional space and obtaining the 3D coordinate corresponding to the relative coordinate comprises:
normalizing the third 2D coordinate to obtain fourth 2D coordinate;
determining, with reference to the fourth 2D coordinate and a distance from a virtual viewpoint to a virtual imaging plane in the virtual three-dimensional space, 3D coordinate of the first key point after being projected into the virtual three-dimensional space.

8. The method according to claim 7, wherein normalizing the third 2D coordinate to obtain the fourth 2D coordinate comprises:
normalizing the third 2D coordinate with reference to a size of the second part and a center coordinate of the second 2D coordinate system to obtain the fourth 2D coordinate.

9. The method according to claim 7, wherein determining, with reference to the fourth 2D coordinate and the distance from the virtual viewpoint to the virtual imaging plane in the virtual three-dimensional space, the 3D coordinate of the first key point projected into the virtual three-dimensional space comprises:
determining, with reference to the fourth 2D coordinate, the distance from the virtual viewpoint to the virtual imaging plane in the virtual three-dimensional space, and a scaling ratio, the 3D coordinate of the first key point projected into the virtual three-dimensional space.

10. The method according to claim 1, further comprising:
determining a number M of the target objects and a 2D imaging region of each target object in the 2D image, wherein the M is an integer greater than 1,
wherein obtaining the first 2D coordinate of the first key point and the second 2D coordinate of the second key point from the 2D image comprises:
obtaining first 2D coordinate of the first key point and second 2D coordinate of the second key point of each target object according to the 2D imaging region to obtain M sets of 3D coordinates.

11. The method according to claim 1, further comprising:
displaying a control effect based on the 3D coordinate in a first display region;
displaying the 2D image in a second display region corresponding to the first display region.

12. The method according to claim 11, wherein displaying the 2D image in the second display region corresponding to the first display region comprises:
displaying, according to the first 2D coordinate, a first reference graphic of the first key point on the 2D image displayed in the second display region, wherein the first reference graphic is an image superimposing displayed on the first key point; and/or,
displaying, according to the second 2D coordinate, a second reference graphic of the second key point on the 2D image displayed in the second display region, wherein the second reference graphic is an image superimposing displayed on the second key point.

13. The method according to claim 1, further comprising:
controlling the coordinate conversion of the target object on the controlled device based on amount of change or a change rate of the relative coordinate on three coordinate axes in the virtual three-dimensional space between two time points.

14. An electronic device, comprising:
a memory; and
a processor connected to the memory, and by executing computer executable instructions stored on the memory, the processor is caused to:
obtain a two-dimensional (2D) image comprising at least one target object;
obtain first 2D coordinate of a first key point and second 2D coordinate of a second key point from the 2D image, wherein the first key point is an imaging point of a first part of the target object in the 2D image, and the second key point is an imaging point of a second part of the target object in the 2D image;
determine relative coordinate based on the first 2D coordinate and the second 2D coordinate, wherein the relative coordinate is used for characterizing a relative position between the first part and the second part;
project the relative coordinate into a virtual three-dimensional (3D) space and obtain 3D coordinate corresponding to the relative coordinate, wherein the 3D coordinate is used for controlling coordinate conversion of the target object on a controlled device.

15. The device according to claim 14, wherein the first 2D coordinate and the second 2D coordinate are 2D coordinates located in a first 2D coordinate system;
wherein when determining the relative coordinate based on the first 2D coordinate and the second 2D coordinate, the processor is further caused to:
construct a second 2D coordinate system according to the second 2D coordinate;
map the first 2D coordinate into the second 2D coordinate system to obtain third 2D coordinate;
determine the relative coordinate based on the third 2D coordinate.

16. The device according to claim 15, wherein when mapping the first 2D coordinate into the second 2D coordinate system to obtain the third 2D coordinate, the processor is caused to:
determine, according to the first 2D coordinate system and the second 2D coordinate system, a conversion parameter for mapping from the first 2D coordinate system to the second 2D coordinate system;
map the first 2D coordinate into the second 2D coordinate system based on the conversion parameter to obtain the third 2D coordinate.

17. The device according to claim 16, wherein when determining, according to the first 2D coordinate system and the second 2D coordinate system, the conversion parameter for mapping from the first 2D coordinate system to the second 2D coordinate system, the processor is further caused to:
determine a first size of the 2D image in a first direction, and determine a second size of the second part in the first direction;
determine a first ratio between the first size and the second size;
determine the conversion parameter according to the first ratio.

18. The device according to claim 17, wherein when determining the conversion parameter according to the first ratio, the processor is further caused to:
determine a third size of the 2D image in a second direction, and determine a fourth size of the second part in the second direction, wherein the second direction is perpendicular to the first direction;
determine a second ratio between the third size and the fourth size;
determine the conversion parameter with reference to the first ratio and the second ratio.

19. The device according to claim 16, wherein when mapping the first 2D coordinate into the second 2D coordinate system based on the conversion parameter to obtain the third 2D coordinate, the processor is further caused to:
map, based on the conversion parameter and a center coordinate of the first 2D coordinate system, the first 2D coordinate into the second 2D coordinate system to obtain the third 2D coordinate.

20. A computer storage medium having computer executable instructions stored thereon, wherein the computer executable instructions are executed by a processor to:
obtain a two-dimensional (2D) image comprising at least one target object;
obtain first 2D coordinate of a first key point and second 2D coordinate of a second key point from the 2D image, wherein the first key point is an imaging point of a first part of the target object in the 2D image, and the second key point is an imaging point of a second part of the target object in the 2D image;
determine relative coordinate based on the first 2D coordinate and the second 2D coordinate, wherein the relative coordinate is used for characterizing a relative position between the first part and the second part;
project the relative coordinate into a virtual three-dimensional (3D) space and obtain 3D coordinate corresponding to the relative coordinate, wherein the 3D coordinate is used for controlling coordinate conversion of the target object on a controlled device.
